(19) United States
(12) Patent Application Publication
(10) Pub. No.: US 2011/0209370 A1
(43) Pub. Date: Sep. 1, 2011

(54) MOBILE PRESENTATION DEVICE

(76) Inventor: Tomas Sköld, Nacka (SE)

(21) Appl. No.: 13/127,673

(22) PCT Filed: Nov. 10, 2009
(86) PCT No.: PCT/SE2009/051283

§ 371 Date: May 4, 2011

(30) Foreign Application Priority Data
Nov. 14, 2008 (SE) 0802397-0

(51) Int. Cl. G09F 21/00; H04R 1/02

(52) U.S. Cl. 40/587; 381/388

(57) ABSTRACT

The invention relates to a mobile presentation device (1) having a first wheel (2) and a second wheel (3), where the first (2) and second (3) wheels each comprises an outer ring (4) rotatably arranged around an inner ring (5). Furthermore, the inner ring (5) has a first side (6) and a second side (7), wherein a presentation surface (8) is arranged on the second side (7). Further, the first (2) and second (3) wheels are fixed parallel to each other by means of a bar device (9) by which the inner rings (5) of the first (2) and second (3) wheels are connected.

### TECHNICAL FIELD

The present invention relates to a mobile presentation device of information and/or advertising.

### BACKGROUND OF THE INVENTION

Devices for presenting information and/or advertising are common in today's society. A non-complete classification of such devices is the classification into mobile and stationary devices for presentation, respectively. Examples of stationary devices are advertising pillars and advertising spaces arranged on buildings or the like. To the category of mobile devices for presentation may for example be mentioned advertising signs carried by persons (by so called “sandwich men”) and advertising devices arranged on vehicles, such as cars, busses and trams.

Document WO9729474 shows a mobile presentation device comprising a substantially vertical carrying surface and a base unit driven by an electro engine. Further, document IE000173 shows a mobile presentation device which can be pulled by a bicycle, wherein the device comprises two boards for showing advertising, which are connected to each other and arranged on a wheel device.

### SUMMARY OF THE INVENTION

The object of the present invention is to provide a mobile device by which information or advertising can be presented.

The object is achieved by a mobile presentation device having a first wheel (2) and a second wheel (3), where the first (2) and second (3) wheels each comprises an outer ring (4) rotatably arranged around an inner ring (5). Furthermore, the inner ring (5) has a first side (6) and a second side (7), wherein a presentation surface (8) is arranged on the second side (7). Further, the first (2) and second (3) wheels are fixed parallel to each other by means of a bar (9) with which the respective inner rings (5) of the first (2) and second (3) wheels are connected. Embodiments of the device according to the invention are disclosed in the dependent claims 2-10.

With a mobile device according to the invention an alternative mobile presentation device of information or advertising is provided, which in a simple and flexible way can be moved.

### BRIEF DESCRIPTION OF THE DRAWINGS

In the following detailed description preferred embodiments of the invention will be described with reference to the appended figures in which:

FIG. 1 schematically shows an embodiment of a presentation device according to the present invention;

FIG. 2A shows, in an explosion view, an example of a wheel intended for a device according to the invention;

FIG. 2B shows a detailed view of the wheel in FIG. 2A; and

FIG. 3 shows an example of a guiding roll.

### DESCRIPTION OF PREFERRED EMBODIMENTS OF THE INVENTION

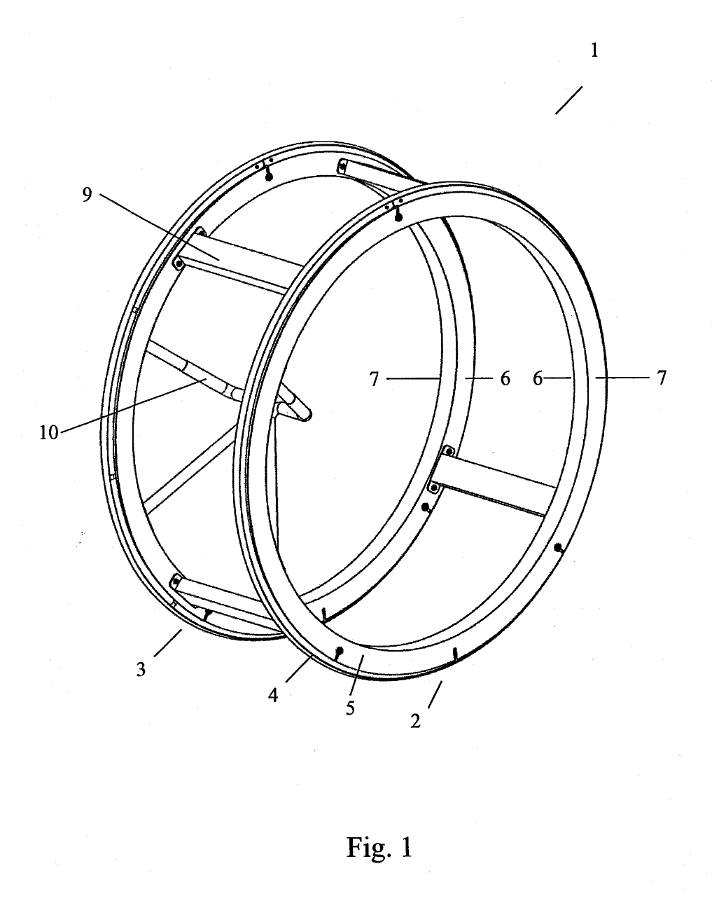

FIG. 1 shows a presentation device 1 according to the present invention. Said presentation device 1 has a first 2 and a second 3 wheel, which are arranged parallel to each other. Each of the wheels 2, 3 in turn comprises an outer ring 4 rotatably arranged around an inner ring 5 having a first 6 and a second side 7. The first side 6 of the inner ring 5 of the wheel 2, 3 is defined as the side on the inner ring 5 which is directed towards the other wheel 2, 3 in its axial direction as shown in FIG. 1.

The two wheels 2, 3 are fixed parallel to each other by means of a bar device 9, the function of which is to connect the first 2 and second 3 wheels. In the embodiment shown in FIG. 1, the bar device 9 comprises four bar elements which in this case connect the first sides 6 on the inner 5 rings, respectively. It is however realised that the number of bar elements can be varied and the same goes for where the bar elements are arranged on the inner 5 rings. The important thing is that the wheels 2, 3 are securely fixed to each other and substantially parallel to each other. For example, a solution with two bar elements connecting the second sides 7 of the inner rings 5, respectively, could be a well functioning solution. Also, it is advantageous if the bar device 9 is detachable from the wheels 2, 3 so that the presentation device 1 can be dismounted for simplifying transportation of the same.

On the second sides 7 of the respective inner rings 5 a presentation surface not shown is arranged for presentation of information and/or advertising. The presentation surface can be in the form of a printed surface on cardboard, cloth, plastic or any other suitable material, but can also be in the form of an electronic screen/display possibly with accompanying processor, memory and input unit. With the latter embodiment change of the information or advertising to be shown on the presentation surface is substantially simplified. Further, the presentation device 1 can also comprise one or more of: a sound, a speaker and a light unit for complementing and/or boosting the visual information that is shown on the presentation surface.

In the embodiment of FIG. 1, the presentation device 1 also comprises a handle 10, which means that operation of the device 1 is simplified. In this example, the handle 10 is arranged in such a way that it connects the respective inner rings 5 of the wheels 2, 3. With such an embodiment the handle 10 also provides yet another function by also functioning as a bar between the first 2 and second 3 wheels. For this reason, the presentation device 1 in an embodiment not shown can comprise one handle 10 and only one bar element, which for example are arranged on each half of the wheels 2, 3.

To further simplify the operation of the presentation device 1 it may also comprises a brake device (not shown in the figures) by which the presentation device 1 can be braked. The brake device can for example be a design comprising one or more brake callipers, which at braking will lie against the outer ring 4, and be controlled by brake wires, brake hydraulics or any other equivalent design. It is also realised that the brake device can be of any other design known to the skilled person.

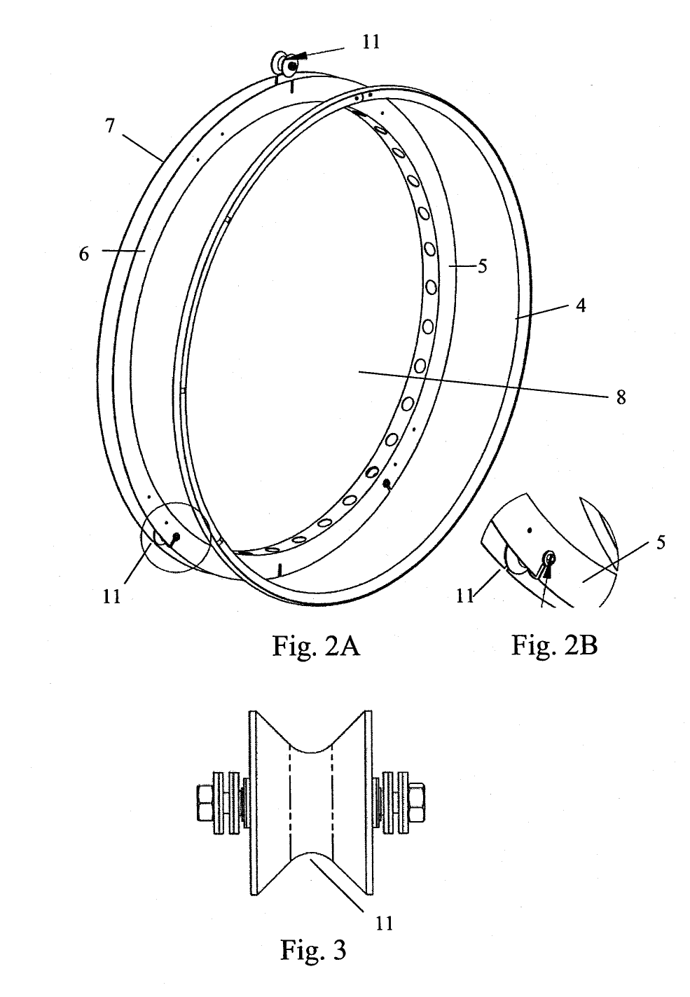

In FIGS. 2A and 2B an example of a wheel 2, 3 is shown to be part of a presentation device 1 according to the invention. As shown in FIG. 2A an outer ring 4 is rotatably arranged on an inner ring 5. For achieving said function a plurality of guiding rolls 11 can be arranged between the outer 4 and inner 5 rings, which is also shown in FIG. 3. Further, one or more of said guiding rolls 11 can have spring action in radial direction between the outer 4 and inner 5 rings for simplifying operation on rough surface and/or for improving the comfort when operating the same. For the same purpose and for increasing the friction against the surface the outer ring 4 can additionally be provided with a rubber layer on its outer side as shown in FIG. 2A.

The operation of the presentation device 1 according to the invention is performed by a person standing between the first 2 and second 3 wheels and with the hands grip any part of the bar 9, or the handle 10 if such is arranged on the presentation device 1. Thereafter, the person moves forwards (for example by walking), wherein the outer rings 4 of the wheels 2, 3 will rotate around the inner rings 5, resulting in that the presentation device 1 will move in a forward direction. In a corresponding way, the presentation device 1 can also be operated in a backwards direction by the person moving backwards.

1. Mobile presentation device, characterised in that:
the mobile presentation device (1) has a first wheel (2) and a second wheel (3);
the first (2) and second (3) wheels each comprises an outer ring (4) rotatably arranged around an inner ring (5);
the inner ring (5) has a first side (6) and a second side (7), wherein a presentation surface (8) is arranged on the second side (7); and
the first (2) and second (3) wheels are fixed parallel to each other by means of a bar device (9) with which the respective inner rings (5) of the first (2) and second (3) wheels are connected.

2. Mobile presentation device (1) according to claim 1, wherein the bar device (9) connects the first sides (6) of the respective inner rings (5) of the first (2) and second (3) wheels.

3. Mobile presentation device (1) according to claim 1, where the mobile presentation device (1) comprises a handle (10) connected to the inner rings (5) of the first (2) and second wheels (3) for simplifying operation of the mobile presentation device (1).

4. Mobile presentation device (1) according to claim 1, wherein the outer ring (4) is rotatably arranged around the inner ring (5) by a plurality of guiding rolls (11) arranged between the outer (4) and inner (5) rings.

5. Mobile presentation device (1) according to claim 4, wherein at least one of the guiding rolls (11) has spring action in radial direction between the outer (4) and inner (5) rings.

6. Mobile presentation device (1) according to claim 1, wherein the presentation surface (8) is an electronic screen/display or a printed surface for presentation of information and/or advertising.

7. Mobile presentation device (1) according to claim 1, wherein the bar device (9) is detachably arranged on the first sides (6) of the respective inner rings (5) of the first (2) and second (3) wheels.

8. Mobile presentation device (1) according to claim 1, wherein the mobile presentation device (1) further comprises a brake device with which the mobile presentation device (1) can be braked.

9. Mobile presentation device (1) according to claim 1, wherein the mobile presentation device (1) further comprises one or more in the group o: a sound unit, a speaker unit, and a light unit.

10. Mobile presentation device (1) according to claim 1, wherein the outer ring (4) supports a rubber layer.
